(19) United States
(12) Patent Application Publication
(10) Pub. No.: US 2005/0145571 A1
(43) Pub. Date: Jul. 7, 2005

(54) Extraction and recovery of ions from a solution

(76) Inventors: Steven H. Strauss, Fort Collins, CO (US); Matthew A. Odom, Elkton, MD (US)

Correspondence Address: FAEGRE & BENSON LLP;PATENT DOCKETING, 2200 WELLS FARGO CENTER, 90 SOUTH 7TH STREET, MINNEAPOLIS, MN, 55402-3901, US

(21) Appl. No.: 10/501,884

(22) PCT Filed: Jun. 27, 2002
(86) PCT No.: PCT/US02/20973

(30) Foreign Application Priority Data
Jun. 29, 2001 (US) 60302052

(51) Int. Cl. C02F 1/42

(52) U.S. Cl. 210/670; 210/683

(57) ABSTRACT

The present invention provides solid ion-extractant and a method for using the same in extracting and recovering ions in a solution. In particular, the present invention provides a method for extracting and recovering ions which are relatively insoluble in a solvent at a particular solvent temperature range. More specifically, the present invention provides a method for extracting and recovering perfluoroalkylsulfonates from an aqueous solution.

### FIELD OF THE INVENTION

The present invention is directed to a solid ion-extractant comprising a solid support and an ion-coordinating agent and a method for using the same.

### BACKGROUND OF THE INVENTION

One of the most commonly used method for removing a particular type of ions from a solution involves an ion-exchange process in which the ion to be removed from the solution is exchanged with a different ion using a solid ion-exchange resin. Generally, this process involves reversible exchange of ions between a liquid phase (i.e., the solution) and a solid phase (i.e., ion-exchange resin). The “extracted” ions are then typically recovered as a solution using another ion exchange process or as a part of the solid phase. The latter recovery process is undesirable as this requires a fresh supply of the solid ion-exchange resin for each ion extraction and recovery process. If the ions (specifically, the corresponding salts) are relatively insoluble, then the former recovery process requires a large volume of solvent to recover the extracted ions.

Perfluoroalkylsulfonates (PFS's), e.g., CₙF₂ₙ₊₁SO₃⁻, typically having potassium counter cation, are widely used as foaming agents, e.g., in fighting fires. While PFS's are vital ingredients in fire fighting, they are undesirable pollutants in water supply. These PFS's in waste water poses problem to water treatment. facilities as they tend to cause foaming and are difficult to remove. Moreover, PFS's are both chemically and thermally very stable; therefore, they cannot be easily removed from water or destroyed by a simple chemical or thermal process. Currently, there is no effective method of efficiently removing PFS's from waste water. Furthermore, because PFS's are relatively insoluble in water at a relatively low temperature, i.e., at or below ambient temperature, even if they are removed from water by an ion-exchange process, a relatively large amount of water is required to recover the extracted PFS's. Moreover, current ion-exchange resins are not particularly selective for PFS's, thus necessitating the use of a large excess of ion-exchange resins.

Therefore, there is a need for a method for removing and recovering PFS's from an aqueous solution which does not require a large volume of recovery water. There is also a need for an ion-exchange resin which is selective for PFS's.

### BRIEF SUMMARY OF THE INVENTION

The present invention is directed to methods and compounds which are useful in extracting ions from a solution. Preferably, the ion has different solubility at different solvent temperatures. For example, the ion can be highly soluble at a low solvent temperature and only sparingly soluble at a high solvent temperature. Or the ion can be only sparingly soluble at a low solvent temperature and highly soluble at a high solvent temperature. Preferably, the solubility ratio between the ion with its corresponding counter ion at a solvent temperature of 50° C. or above and at a solvent temperature of less than 30° C. is at least about 5, more preferably at least about 10, still more preferably at least about 100, and most preferably at least about 1000. The ion can be anion or cation.

### BRIEF DESCRIPTION OF THE DRAWINGS

FIG. 1 is a schematic drawing of a method for removing and recovering ions of the present invention;

FIG. 2 shows exemplary coupling catalysts which are useful in preparing the extractant compounds of the present invention from the corresponding olefins and silane compounds;

FIG. 3 shows concentration of PFS anions before and after extraction with HEP⁺NO₃⁻/XAD-7; and

FIG. 4 shows a relative NIEMS intensities of PFS anions recovered from the cold trap during the PFS anion extraction and recovery process of the present invention.

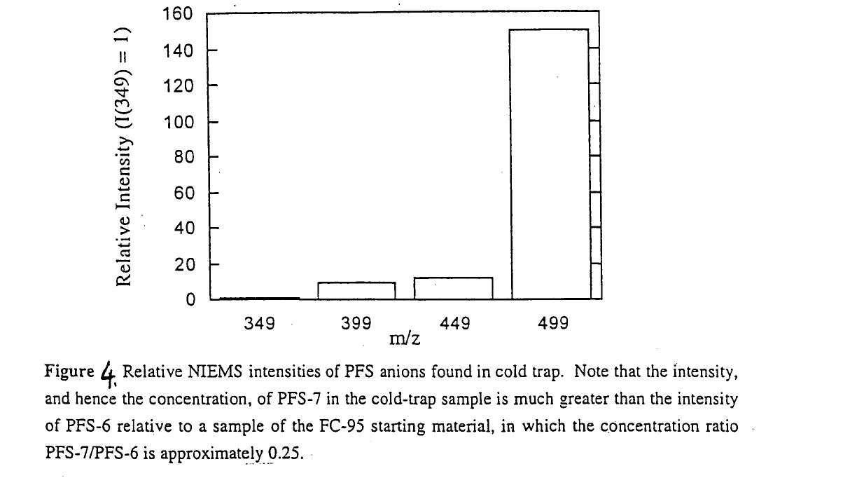

### DETAILED DESCRIPTION OF THE INVENTION

This detailed description of the invention is presented for purposes of convenience and illustration for the case of removing perfluoroalkylsulfonates from an aqueous solution. It is to be understood, however, that the invention as a whole is not intended to be so limited, and that one skilled in the art will recognize that the concept of the invention will be applicable to removing other ions, which are relatively insoluble at a given solvent temperature range, from both aqueous and non-aqueous solutions, e.g., organic solutions, in accordance with the techniques discussed herein. Other ions suitable for removal and recovery using the present invention will be readily apparent to those skilled in the art.

A method for removing and recovering PFS's from aqueous layer will now be described with regard to the accompanying drawings which assist in illustrating various features of the invention. In this regard, the present invention generally relates to removing and recovering ions of salts which are relatively insoluble from a solution. In particular, the present invention relates to removing and recovering PFS's from an aqueous solution.

It should be appreciated that ions, such as PFS anions, of the present invention themselves do not necessarily comprise chemical compounds which can be isolated. Indeed, in an isolable compound, ions such as PFS anions must be paired with cations to maintain electroneutrality. Thus, it is to be understood that isolation or recovery of an ion refers to isolation or recovery of its corresponding salt.

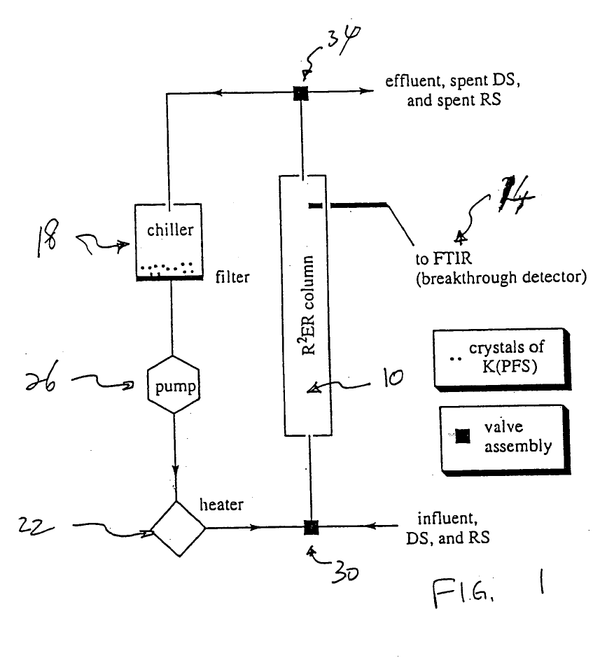

One particular embodiment of a method for removing PFS's from an aqueous solution is generally illustrated in FIG. 1, which is provided for the sole purpose of illustrating the practice of the present invention. FIG. 1 does not constitute limitations on the scope of the present invention.

Alkali metal, e.g., potassium, sodium or lithium, salts of PFS anions which are used as foaming agents in fire fighting are relatively insoluble, i.e., solubility of less than about 1 g/L, in water at ambient temperature (i.e., room temperature). These PFS salts in wastewater cause foaming and are difficult to remove by current conventional wastewater treatment processes. Moreover, because PFS ions are both chemically and thermally stable, they are difficult to remove from wastewater. One possible method of removing PFS ions from wastewater (or from an aqueous solution in general) is to use an ion-exchange process. Unfortunately, due to low solubility in water, a large volume of water is required to recover PFS's from the ion-exchange resin, which defeats the purpose of trying to remove PFS's from water in the first place. Moreover, use of a fresh source of ion-exchange resin for each PFS extraction process is economically not feasible.

The present inventors have discovered a new extraction and isolation method which takes advantage of the low solubility of PFS anions. Moreover, the present inventors have discovered a new solid ion-extractant which is specific for coordinating PFS anions relative to other smaller anions such as halides, including chloride, bromide and iodide; nitrate; phosphate; and other similar anions.

The solid ion-extractant of the present invention can be activated and deactivated to allow coordination and release, respectively, of PFS anions, thereby making the extraction and recovery of PFS anions extremely simple.

As discussed in detail below, when the solid ion-extractant of the present invention is deactivated, the PFS anions which have been concentrated on the solid-ion extractant are released and precipitates on or near the solid ion-extractant. One method of removing these PFS's is to use a large volume of water to dissolve all the PFS's and to recover PFS's as another aqueous solution. This requires removal of a large volume of water to isolate the PFS's, which requires a large amount of time and energy. By using the extraction and recovery process of the present invention, the volume of water required to remove extracted PFS's are significantly reduced. Furthermore, methods of the present invention allow a simple and facile recovery of the extracted PFS's.

As shown in FIG. 1, a column 10 of solid ion-extractant, discussed in detail below, is activated by adding a solution containing an ion-extractant activating compound. An aqueous solution containing PFS anions is then passed through the activated solid ion-extractant. This removes (i.e., extracts) PFS anions from the aqueous solution and concentrates them on or near the solid ion-extractant. The amount of solid ion-extractant used depends on the amount of PFS's present in the aqueous solution as well as the amount of ion-extractant compound present in the solid ion-extractant. Typically, the total amount of ion-extractant compound in the column 10 is from about 1.4 to about 1.8 times the amount of total PFS anions present in the aqueous solution. The rate of aqueous solution flow through the column 10 affects the efficiency of PFS anion removal. Generally, the faster the flow rate, less efficient the removal.

The column 10 can be interconnected to a detector 14 to determine whether the effluent aqueous solution from column 10 contains PFS anions. Exemplary detectors which are useful in detecting ions present in an aqueous solution include an Fourier Transform Infrared (FTIR) detector, in particular FTIR detector described in a commonly assigned U.S. Provisional Patent Application No. 60/227,758, entitled “Detection of Ions in a Fluid Medium” filed on Aug. 24, 2000, which is further identified by Attorney Docket No. 019397-000500US, which is incorporated herein by reference in its entirety.

After extracting PFS's, the column 10 is flushed with an ion-extractant deactivating solution. This results in precipitation and/or release of concentrated PFS salts from the solid ion-extractant. The column is then flushed with water that is at least about 85° C., which dissolves PFS salts. It has been found by the present inventors that the solubility of PFS salts increases as the temperature of water increases. Thus, methods of the present invention utilizes this difference in solubility of PFS salts in different water temperature to isolate (i.e., recover) PFS salts from an aqueous solution.

The resulting hot water which contains dissolved PFS salts is then cooled by a chiller 18 to precipitate dissolved PFS salts. The solid PFS salts is then separated, e.g., by filtration, centrifugation or by other solid-liquid separation techniques known to one of ordinary skill in the art.

To minimize the volume of water used in the process, the separated water can be reheated by the heater 22 and reused to further remove PFS salts from the column 10. In this manner, a significantly small volume of water can be used to recover PFS salts by using a recirculating water pump 26, which may be located anywhere along the recirculating path.

After PFS salts have been removed from the column 10, the solid ion-extractant can be reactivated by introducing a solution of activating, e.g., oxidizing, agent through the column 10. In this manner, the solid ion-extractant can be recycled and reused.

Methods of the present invention can also include providing a valve systems (30 and 34) which allows introduction and removal of activating or deactivating agents through a different source than the PFS salt recovery water source. This reduces or prevents PFS salts being contaminated with the activating and/or deactivating agents. Contamination can be further reduced by flushing the column 10 with cold water, i.e., less than about 5° C., after activating or deactivating the solid ion-extractant in the column 10, thereby removing residual activating or deactivating agents which may be present in the column 10.

The solid ion-extractant of the present invention includes a solid support and an ion-coordinating moiety (i.e., extractant compound), which are covalently bonded.

Preferably, the solid support is a glass or a polymeric resin. Exemplary polymeric resins which are useful in the present invention include, but not limited to, acrylic esters (e.g., Supelco® XAD-7 and DAX-8), polyvinyls, polystyrenes, polypyrroles, polyolefins, and polyaromatics (e.g., Supelco® XAD-1180). Preferably the polymeric resin is selected from the group consisting of polydivinylbenzene, polyvinylchloride, polyvinyl alcohol, polystyrene, polypyrrole, polymethacrylate, and functionalized polyolefin, more preferably from the group consisting of polystyrene, polymethacrylate and polyacrylic ester, and most preferably from the group consisting of polyacrylic ester.

Preferably, the ion-extractant has a high selectivity for PFS anions. The ion-extractant compound of the present invention can includes a lipophilic portion which provides increased interaction with and/or selectivity for PFS's in the aqueous solution. Preferably, the ion-extractant compounds are redox-recyclable compounds. As used herein, a “redox-recyclable compound” refers to an ion-extractant compound which can be activated and deactivated by oxidation and reduction, respectively. For example, typically the ion-extractant compound is a neutral compound which is oxidized (i.e., activated) to a cation containing a corresponding anion. Useful corresponding anions include, but are not limited to, nitrate (NO₃⁻), halide (e.g., F⁻, Cl⁻ Br⁻ and I⁻), HSO₄⁻, ClO₄⁻, ReO₄⁻, PF₆⁻, carboxylates (e.g., acetate) and CF₃SO₃⁻. When this oxidized ion-extractant compound is contacted with an aqueous solution containing PFS anions, it undergoes exchange of anions, thereby concentrating PFS anions onto the solid ion-extractant. The concentrated PFS's can be removed from the solid ion-extractant by simply reducing (i.e., deactivating) the extractant compound to regenerate the neutral extractant compound. In this manner, the solid ion-extractant can be activated and deactivated rapidly and reused repeatedly.

The ion-extractant compounds of the present invention can be reduced and oxidized using a chemical reducing agent and a chemical oxidizing agent, respectively, or by electrochemically. Exemplary chemical oxidizing agents include, but are not limited to, Fe(NO₃)₃, AgNO₃, FeCl₃, AgF, NaOCl, Ce(NH₄)₂(NO₃)₆ and Ce(SO₄)₂. Preferably, the oxidizing agent is selected from the group consisting of Fe(NO₃)₃, AgNO₃, FeCl₃ and Ce(NH₄)₂(NO₃)₆, more preferably from the group consisting of Fe(NO₃)₃, AgNO₃ and Ce(NH₄)₂(NO₃)₆, and most preferably from the group consisting of Fe(NO₃)₃ and AgNO₃. Exemplary chemical reducing agents include, but are not limited to, Na₄Fe(CN)₆, K₄Fe(CN)₆, Na₂S₂O₄, Cr²⁺ salts, V²⁺ salts and NaBH₄. Preferably, the reducing agent is selected from the group consisting of Na₄Fe(CN)₆, Na₂S₂O₄, NaBH₄ and Cr²⁺ salt, more preferably from the group consisting of Na₄Fe(CN)₆, Na₂S₂O₄ and NaBH₄, and most preferably from the group consisting of Na₄Fe(CN)₆ and Na₂S₂O₄.

In one particular embodiment of the present invention, the ion-extractant compounds are organometallic compounds (e.g., transition-metal complexes) that are very stable as neutral complexes and as one-electron oxidized cations. Ion-extractant compounds of the present invention are substantially kinetically inert to substitution in both redox states. Preferably ion-extractant compounds of the present invention include polydentate ligands. Moreover, it is also preferred that the ion-extractant compounds do not contain acid- or base-labile functional groups.

Preferably, the ion-extractant compounds of the present invention have redox potentials that allow the use of simple, inexpensive oxidants or reductants and undergo rapid one-electron oxidation or reduction. Moreover, it is preferred that the ion-extractant compounds do not undergo over-oxidation or over-reduction in the presence of an excess of oxidant or reductant, respectively. Preferably, the ion-extractant compounds are relatively nontoxic (e.g., iron complexes are preferred to chromium complexes).

Preferably, the ion-extractant compounds of the present invention are relatively inexpensive (e.g., iron complexes are preferred to ruthenium complexes). Furthermore, the ion-extractant compounds of the present invention have negligible water solubility in both working oxidation states. For example, for removing and recovering a large and weakly-hydrated anions, such as PFS anions, the ion-extractant compounds are selected from salts of a large, lipophilic cation having a small hydrophilic counter anion, because the large size of the ion-extractant compound increases the selectivity of the solid ion-extractant for the large anions such as PFS's.

Preferably, the amount of ion-extractant compound bonded (i.e., attached) to the surface of the solid support allows sufficient interaction between the ion-extractant compound and PFS's, thereby efficiently removing the PFS's from the aqueous solution. The lipophilic portion of the ion-extractant compound serves to increase the selectivity of the ion-extractant compound for PFS anions and/or interaction between the ion-extractant compound and PFS anions.

In one particular embodiment of the present invention, the solid ion-extractant is a composition of formula I: 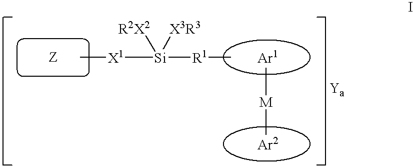
where each of Ar¹ and Ar² is independently C₄-C₂₀ aryl; M is a transition metal; R¹ is C₂-C₂₀ alkylene; each of X¹, X² and X³ is independently a bond, O, S, or NR⁴; each of R², R³ and R⁴ is independently H, or C₁-C₆ alkyl; Z is a solid support; Y is an anion; and a is 0 when the extractant compound is deactivated (i.e., reduced), and a is an integer from 1 to 3 when the extractant compound is activated (i.e., oxidized). Alternatively, —X²R² and/or —X³R³ can be halide, preferably chloride.

“Alkyl” groups according to the present invention are aliphatic hydrocarbons which can be straight or branched chain groups. Alkyl groups optionally can be substituted with one or more substituents, such as a halogen, alkenyl, alkynyl, aryl, hydroxy, amino, thio, alkoxy, carboxy, oxo or cycloalkyl. There may be optionally inserted along the alkyl group one or more oxygen, sulfur or substituted or unsubstituted nitrogen atoms. Exemplary alkyl groups include methyl, ethyl, i-propyl, n-butyl, t-butyl, fluoromethyl, difluoromethyl, trifluoromethyl, chloromethyl, trichloromethyl, and pentafluoroethyl.

“Aryl” groups are monocyclic or bicyclic carbocyclic or heterocyclic aromatic ring moieties. Aryl groups can be substituted with one or more substituents, such as a halogen, alkenyl, alkyl, alkynyl, hydroxy, amino, thio, alkoxy or cycloalkyl. Exemplary aryl groups include pyrrole, thiophene, furan, imidazole, pyrazole, 1,2,4-triazole, pyridine, pyrazine, pyrimidine, pyridazine, thiazole, isothiazole, oxazole, isoxazole, s-triazine, benzene, indene, isoindene, benzofuran, dihydrobenzofuran, benzothiophene, indole, 1H-indazole, indoline, azulene, tetrahydroazulene, benzopyrazole, benzoxazole, benzoimidazole, benzothiazole, 1,3-benzodioxole, 1,4-benzodioxan, purine, naphthalene, tetralin, coumarin, chromone, chromene, 1,2-dihydrobenzothiopyran, tetrahydrobenzothiopyran, quinoline, isoquinoline, quinazoline, pyrido[3,4-b]-pyridine, and 1,4-benisoxazine.

With respect to the above compound I:

Preferably M is Fe, Ru, Mn, Co, Ni, Cr, Os, Rh or Ir. More preferably, M is Fe or Ru.

Preferably R¹ is C₂-C₁₂ alkylene, more preferably C₂-C₈ alkylene, still more preferably C₂-C₆ alkylene, and most preferably 2-methyl hexylene or ethylene.

Preferably Ar¹ and Ar² are independently cyclopentadienyl, dicarbollide or phenyl, each of which can be optionally substituted.

Preferably, X¹, X² and X³ are O.

Preferably, R² and R³ are C₁-C₆ alkyl. More preferably R² and R³ are independently methyl, ethyl, isopropyl, butyl, or pentyl.

Preferably, a is 1 when the extractant compound is activated, i.e., oxidized.

The solid ion-extractant of formula I can be prepared by contacting the solid support of composition II: 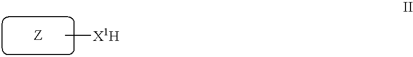
with the extractant compound of formula III: 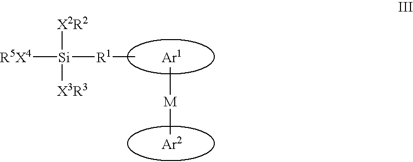
where R⁵ is independently H or C₁-C₆ alkyl; X⁴ is independently a bond, O, S, or NR⁴; and Ar¹, Ar², X¹, X², X³, R¹, R², R³, R⁴, M and Z are described above. Preferably, R⁵ is H, methyl, ethyl, isopropyl or butyl. Preferably, X⁴ is O. Alternatively —X⁴R⁵ can be halide, preferably chloride.

The ion-extractant compounds of formula III can be prepared by contacting an olefin of formula IV: 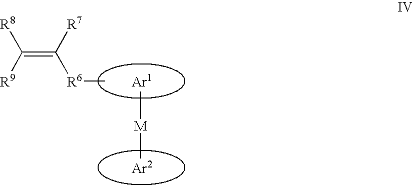
with a silane compound of formula V:
HSi(X²R²)(X³R³)(X⁴R⁵) V
in the presence of a coupling catalyst, where Ar¹, Ar², X¹, X², X³, R¹, R², R³, R⁴, M, Z, R⁵ and X⁴ are described above; R⁶ is a bond or C₁-C₁₈ alkylene; and each of R⁷, R⁸ and R⁹ is independently H or C₁-C₆ alkyl. Preferably, R⁶ is a bond or C₁-C₆ alkylene. More preferably R⁶ is a bond or methylene (—CH₂—). Preferably, R⁷, R⁸ and R⁹ are H or methyl (—CH₃).

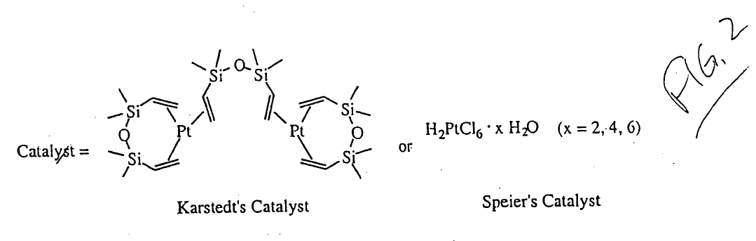

Exemplary coupling catalysts useful for producing ion-extractant compound III from the corresponding olefin IV and silyl compound V are shown in FIG. 2. Preferably, the coupling catalyst is selected from the group consisting of Karstedt's catalyst, Speier's catalyst, other silylplatinum complexes, transition metal nanoclusters, dicobalt octacarbonyl, nickel tetracarbonyl, Wilkonson's catalyst, chromium hexacarbonyl, and zirconocenes.

The olefin compounds IV of the present invention can be synthesized from readily available starting materials. Various substituents on the aryl groups Ar¹ and Ar² can be present in the starting compounds, added to any one of the intermediates or added after formation of the final products by known methods of substitution or conversion reactions. If the substituents themselves are reactive, then the substituents can themselves be protected according to the techniques known in the art. A variety of protecting groups are known in the art, and can be employed. Examples of many of the possible groups can be found in Protective Groups in Organic Synthesis, 2nd edition, T. H. Greene and P. G. M. Wuts, John Wiley & Sons, New York, 1991, which is incorporated by reference herein in its entirety. For example, nitro groups can be added by nitration and the nitro group can be converted to other groups, such as amino by reduction, and halogen by diazotization of the amino group and replacement of the diazo group with halogen. Acyl groups can be added by Friedel-Crafts acylation. The acyl groups can then be transformed to the corresponding alkyl groups by various methods, including the Wolff-Kishner reduction and Clemmenson reduction. Amino groups can be alkylated to form mono- and di-alkylamino groups; and mercapto and hydroxy groups can be alkylated to form corresponding ethers. Primary alcohols can be oxidized by oxidizing agents known in the art to form carboxylic acids or aldehydes, and secondary alcohols can be oxidized to form ketones. Thus, substitution or alteration reactions can be employed to provide a variety of substituents throughout the molecule of the starting material, intermediates, or the final product, including isolated products.

Since the compounds of the present invention can have certain substituents which are necessarily present, the introduction of each substituent is, of course, dependent on the specific substituents involved and the chemistry necessary for their formation. Thus, consideration of how one substituent would be affected by a chemical reaction when forming a second substituent would involve techniques familiar to one of ordinary skill in the art. This would further be dependent on the aryl ring involved.

It is to be understood that the scope of this invention encompasses not only the various isomers which may exist but also the various mixture of isomers which may be formed.

When the compound of the present invention contains an olefin moiety and such olefin moiety can be either cis- or trans-configuration, the compound can be synthesized to produce cis- or trans-olefin, selectively, as the predominant product. Alternatively, the compound containing an olefin moiety can be produced as a mixture of cis- and trans-olefins and separated using known procedures, for example, by chromatography as described in W. K. Chan, et al., J. Am. Chem. Soc., 1974, 96, 3642, which is incorporated by reference herein in its entirety.

Additional objects, advantages, and novel features of this invention will become apparent to those skilled in the art upon examination of the following examples thereof, which are not intended to be limiting.

### Experimental

Experiment 1

This experiment illustrates a method for coupling a silane compound to vinylferrocene.

A variety of silane compounds were coupled to vinylferrocene using different catalysts as shown below:

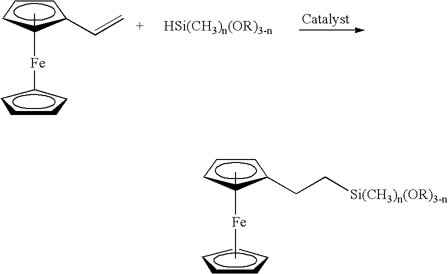

Some of the results are shown on Table 1.

TABLE 1
Vinylferrocene Hydrosilylation Results

| Silane | catalyst^{a} | amt. of catalyst^{b} | % yield^{c} |
|---|---|---|---|
| HSiCl₃ | Karstedt's | 0.08% to 1.6% | no rxn. |
| HSi(CH₃)₂(OEt) | Karstedt's | 0.24% | 67% |
| HSi(CH₃)(OEt)₂ | no catalyst | 0 | no rxn. |
| HSi(OEt)₃ | Karstedt's | 0.40% | 27% |
| HSi(OEt)₃ | Speier's | 0.02% | 17% |
| HSi(OMe)₃ | Karstedt's | 0.16% to 1.6% | <1%^{d} |

^{a}Karstedt's catalyst was purchased as a 2-3% platinum solution (by weight) in xylenes from United Chemical Technologies, Inc. (Bristol, PA) and was assumed to be 2.5% platinum with a solution density of 0.88 g/mL; Speier's catalyst was purchased from Aldrich (Milwaukee, WI) and dissolved in 2-propanol and used as a 0.01 M solution.
^{b}Values are expressed as mole percent platinum relative to the starting amount of vinylferrocene.
^{c}Percent yields given are approximate. Final products still contain minor amounts of impurities.
^{d}Product observed in mass spectrometry.

As shown in Table 1, the presence of electron withdrawing groups on the silane starting material affects the yield of hydrosilylation reaction. For example, no silylated ferrocene was observed for the reaction with HSiCl₃, which has three electron withdrawing chlorine atoms bonded to the silicon atom. The more electron withdrawing groups bonded to the silicon atom, the stronger the Si—H bond becomes and the more difficult it is to add the Si—H moiety across a double bond. This trend can also be seen in the lower yield obtained for the trialkoxysilanes compared to the monoalkoxysilane. The electron withdrawing alkoxy substituents strengthen the Si—H bond while electron donating alkyl groups weaken it.

The hydrosilylation reaction with the dialkylmonoalkoxy silane HSi(CH₃)₂(OEt) produced a greater yield of hydrosilylated product than trialkoxysilane HSi(OEt)₃. In addition, the alkyl substituent of the alkoxy group also affect the product yield. Compare for example, the result between trimethoxysilane and triethoxysilane. Without being bound by a theory, it is believed that the more electron density the oxygen atom receives from the alkyl group, the less electron density it will take from the silicon atom; thus, it is believed that the added electron donating ability of an ethyl group over a methyl group is responsible for the difference in product yield. The overall effect of substituting ethoxy for methoxy groups is to weaken the Si—H bond and make the hydrosilylation reaction more favorable.

Experiment 2

This experiment illustrates the solubility of PFS salts at a different water temperatures.

A 57 mg sample of FC-95 (a mixture of five potassium salts of PFS anions) from 3M company (St. Paul, Minn.) was mixed with 30 mL of water at 23° C. After vigorous mixing, the mixture contained a saturated solution of FC-95 and a considerable amount of solid FC-95. The mixture was heated to 80° C., whereupon all of the solids dissolved. The mixture was then cooled to about 0° C., whereupon white crystals precipitated. The mixture was filtered cold and the crystals were dried to yield 32 mg of solid. The filtrate was concentrated in vacuum to yield 25 mg of white solid.

Experiment 3

This experiment illustrates the thermal stabilities of 1,1′3,3′-tetrakis(2-methyl-2-hexyl)ferrocene (HEP) and 1,1′3,3′-tetrakis(2-methyl-2-hexyl)ferricenium cation (HEP⁺).

A samples of HEP and HEP⁺N₃⁻ were added to water and the resulting mixture was heated to 80° C. for several days. There was no visible degradation of either material when compared with control samples treated with water at 23° C. for the same length of time.

Experiment 4

This experiment illustrates a method for attaching ferrocenes to indium tin oxide (ITO) surfaces.

The ITO coated glass slide was hydroxylated by soaking in a 0.5 M aqueous solution of KOH for 24 hours. The hydroxylated ITO slide was placed in a benzene solution of 1-(2′-triethoxysilylethyl) ferrocene for 24 hours. The slide was then rinsed with benzene and analyzed by cyclic voltammetry, which showed the ferrocene to be attached to the slide.

Experiment 5

This experiment shows efficiency of the PFS anion recovery process of the present invention.

AFFF (FC-203CF Light Water Brand 3% solution from 3M Company) concentrate contains five different PFS anions, C₄ through C₈ PFS anions. The PFS-8, i.e., C₈ PFS, component is about 71 mole %, and its concentration is about 10.9 mM. For the sake of convenience, the following calculations assume PFS-8 is the only PFS anion in AFFF.

The nominal concentration, representing all of the PFS anions, is about 15 mM (10.9/0.71). The wastewater containing AFFF is at most about 3% solution of the concentrate, since this is the standard dilution used to spray on liquid-fuel fires. Therefore, the nominal concentration of PFS-8 in the wastewater is at most about 0.45 mM (about 218 ppm). A typical 16 gallon recovery column 10 holds about 8 Kg of HEP⁺NO₃⁻/XAD-7 (acrylic ester polymer available from Supelco®) with an ion-exchange capacity of about 0.24 mmol/g and a void volume of about 2 gallons (about 8 L). Therefore, the ion-exchange capacity of the column is about 2 mole of PFS-8, or about 880 g of potassium PFS-8.

The flow rate through the column used is about 7 gal/min (or about 3.5 times the void volume per minute). Therefore, about 800 gallons of 0.45 mM PFS-8 solution can be treated during 1.9 hours, resulting in about 1% of PFS-8 being unrecovered (about 2 ppm, well below the 10 ppm foaming level). At this point about 37% of the ion-exchange sites are saturated, i.e., about 325 g of PFS-8 is contained in the column 10.

The solubility of potassium PFS-8 (i.e., KPFS-8) is about 1 g/L or less at 23° C. Therefore, when 1 equiv. of void volume (i.e., 2 L) of deactivation solution flows through the column 10, the resulting effluent will contain only about 8 g of the 325 g of “released” (e.g., precipitated) KPFS-8.

After the deactivating solution is removed from the column 10, the remaining KPFS-8 is recovered using the hot water/cold water process as described above. Thus, starting from about 3200 L (i.e., about 800 gallons) of wastewater, about 0.2 L of crystalline KPFS-8 can be recovered as a solid. This represents a volume reduction by factor of about 15,000.

Experiment 6

This experiment shows efficiency of the PFS anion recovery process of the present invention.

A column having 2.5 cm (diameter) and. 10 cm (length) was filled with about 10.0 g of HEP⁺NO₃⁻/XAD-7 having about 0.248 mmol HEP⁺NO₃⁻ per gram of material.

A saturated solution of FC-95 was made by dissolving 2.5 g of powdered FC-95 in 2 L of heated distilled and deionized water. The solution was allowed to cool to room temperature at which point precipitate was observed due to the decrease in solubility of PFS anions in cooler water. The solution was filtered through #4 Whatman filter paper to remove the precipitate. About 1.5 L of filtrate was pumped through the above column at a rate of about 3.5 ml/min.

The column was then washed with water to removed the excess FC-95 solution. The ion-exchange compound was deactivated by passing a basic solution of Na₂S₂O₄ through the column. Once the deactivation solution had passed through the column, it was diverted through a cold trap (chiller) in order to collect PFS anions that might have dissolved in the solution.

Hot water (96° C.) was then pumped through the column. The hot water was then passed through a cold trap. After 15 minutes a white solid was observed in the cold trap. The cold trap was washed and the white solid was dissolved in water. This final solution of PFS salts was analyzed by NIEMS using 4:1 (v/v) acetonitrile/water. The saturated solutions of FC-95, both before and after extraction, were also analyzed by NIEMS.

FIG. 2 shows the differences in PFS anion peak intensities for the FC-95 solution before and after passing through the column. More than ½ of the PFS-8 and PFS-7 in the original solution have been extracted by the column.

Without being bound by any theory, it is believed that the more weakly hydrated the PFS anion, the larger the equilibrium constant for ion-exchange with the ion-extractant. Therefore, longer-chain PFS anions is extracted preferentially over shorter-chain PFS anions because longer-chain PFS anions have lower hydration energies than shorter-chain PFS anions.

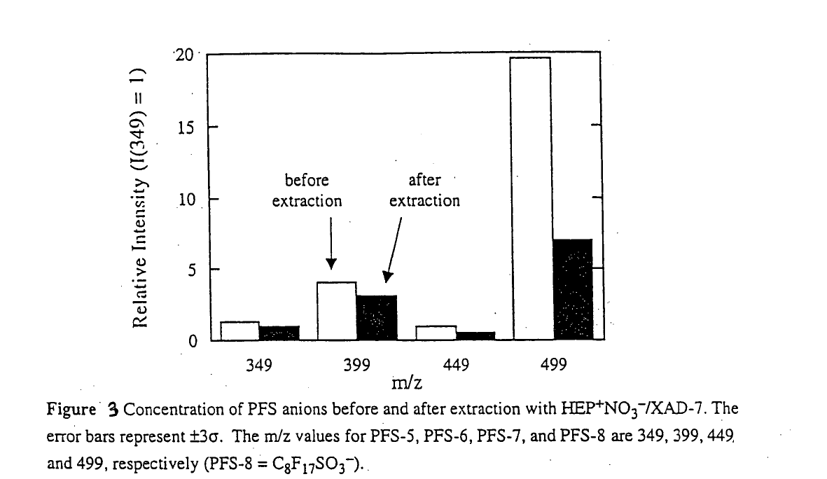

FIG. 3 shows the NIEMS intensities of the PFS anions collected as their potassium salts in the cold trap. PFS-8 is the most abundant anion found in the cold trap. The concentration of PFS-7 in the cold-trap sample is significantly greater than the intensity of PFS-6 relative to a sample of the FC-95 starting material, in which the concentration ratio of PFS-7 to PFS-6 is about 0.25, even though a greater absolute amount of PFS-6 was extracted relative to PFS-7, i.e., the difference between the before and after intensities for PFS-6 in FIG. 2 is greater than the difference for PFS-7.

The present invention, in various embodiments, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, includes providing devices and processes in the absence of items not depicted and/or described herein or in various embodiments hereof, including in the absence of such items as may have been used in previous devices or processes, e.g., for improving performance, achieving ease and/or reducing cost of implementation.

Experiment 7

This example illustrates a method for attaching HEP to a glass or metal surface.

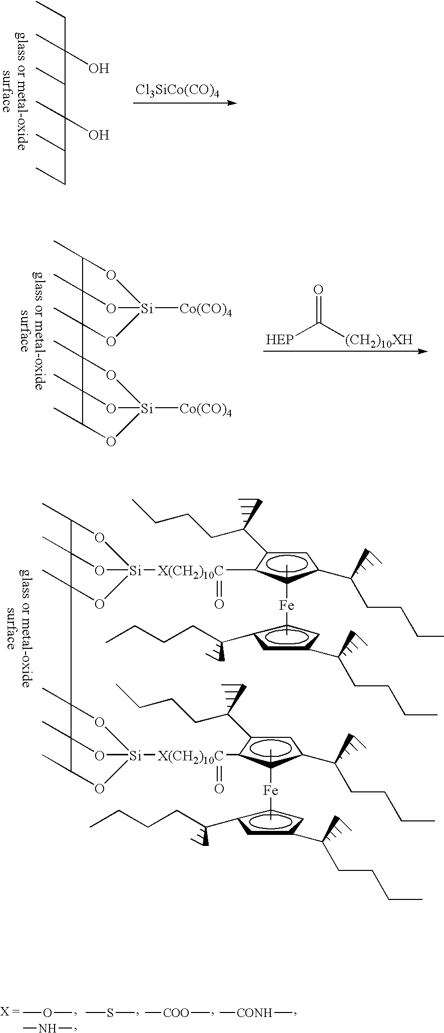

A procedure similar to those disclosed by Kaimin et al., Langmuir 1992, 8, 2585; Herr et al., J. Amer. Chem. Soc. 1994, 116, 1157; and Mirkin et al., U.S. Pat. No. 5,286,571 was used. The procedure generally involves cleaning a glass or metal-oxide surface by hydroxylating it by soaking in a 0.5 to 1.5 M base (KOH or NaOH) in a 1:1 (v:v) H₂O:Ethanol solution for 1 to 24 hours and then rinsing successively with hot distilled water and ethanol. The surface was dried under vacuum. The surface was then soaked in a 0.01 M solution of (CH₃)ₓCl₃₋ₓSiCo(CO)₄ (x=0-2) for 24 hours at room temperature under an inert atmosphere. The surface was then soaked in a 0.01 M solution of HEP-CO—(CH₂)ₙ—X (where X═—OH, —SH, —COOH, —NH₂, —CONH₂) in an appropriate solvent (acetonitrile or dichloromethane) for 24 to 48 hours. The surface was then rinsed with acetonitrile and dichloromethane.

Experiment 8

This example illustrates another method for attaching HEP to a glass or metal surface.

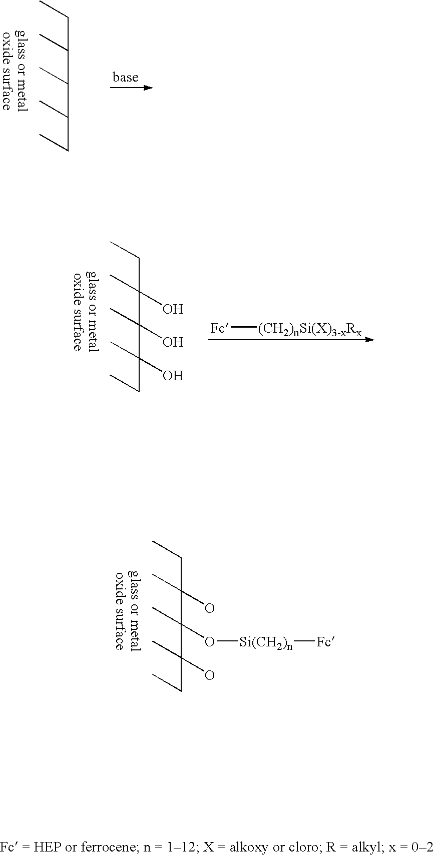

A clean glass or metal-oxide surface was hydroxylated by soaking in a 0.5 to 1.5 M base (KOH or NaOH) in a 1:1 (v:v) H₂O:Ethanol solution for 1 to 24 hours and then rinsing successively with hot distilled water and ethanol and drying under N₂ gas. The slide was then placed in a 0.01M solution of Fc′-(CH₂)ₙSi(X)₃₋ₓRₓ in an appropriate solvent (ethanol, toluene, acetonitrile or dichloromethane) for 24 to 48 hours. The surface was then rinsed with acetonitrile and dichloromethane.

The foregoing discussion of the invention has been presented for purposes of illustration and description. The foregoing is not intended to limit the invention to the form or forms disclosed herein. Although the description of the invention has included description of one or more embodiments and certain variations and modifications, other variations and modifications are within the scope of the invention, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

1. A method for removing and recovering an ion from a solution comprising:
(a) contacting said solution with a solid ion extractant comprising a recyclable activated ion coordinating agent to remove at least a portion of said ion from said solution;
(b) deactivating said ion coordinating agent;
(c) dissolving said ion in a recovery solvent and removing said ion from said solid ion extractant; and
(d) recovering said ion from said recovery solvent.

2. The method of claim 1, wherein said ion is an anion.

3. The method of claim 1, wherein said ion is a perfluoroalkylsulfonate or a perfluoroalkyl carboxylate.

4. The method of claim 1, wherein said ion coordinating agent comprises a lipophilic portion.

5. The method of claim 1, wherein said active ion coordinating agent is ionizable in an aqueous solution.

6. The method of claim 1, wherein said step of removing said ion from said solution comprises an ion-exchange process.

7. The method of claim 1, wherein said ion coordinating agent is an organometallic compound.

8. The method of claim 7, wherein said ion coordinating agent is redox-recyclable.

9. The method of claim 8, wherein said ion coordinating agent is oxidized prior to said step (a).

10. The method of claim 9, wherein said oxidation step comprises an electrochemical oxidation process.

11. The method of claim 9, wherein said oxidation step comprises a chemical oxidation process.

12. The method of claim 8, wherein said deactivation step comprises reducing said ion coordinating agent.

13. The method of claim 12, wherein said reduction step comprises an electrochemical reduction process.

14. The method of claim 12, wherein said reduction step comprises a chemical reduction process.

15. The method of claim 14, wherein said chemical reduction process comprises contacting said solid ion extractant with a deactivating solution.

16. The method of claim 15, wherein said deactivating solution comprises a compound selected from the group consisting of Na₄Fe(CN)₆, K₄Fe(CN)₆, Na₂S₂O₄, Cr²⁺ salt, V²⁺ salt and NaBH₄.

17. The method of claim 1, wherein said solid ion extractant is a composition of the formula: 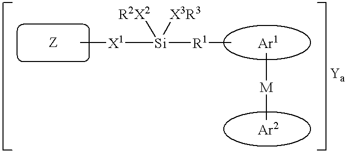
wherein
each of Ar¹ and Ar² is independently C₄-C₂₀ aryl;
M is a transition metal;
R¹ is C₂-C₂₀ alkylene;
each of X¹, X² and X³ is independently a bond, O, S, or NR⁴;
each of R², R³ and R⁴ is independently H, or C₁-C₆ alkyl;
Z is a solid support;
Y is an anion; and
a is 0 when said ion coordinating agent is deactivated, and
a is an integer from 1 to 3 when said ion coordinating agent is activated.

18. The method of claim 17, wherein M is selected from the group consisting of Fe, Ru, Mn, Co, Ni, Cr, Os, Rh and Ir.

19. The method of claim 17, wherein Ar¹ and Ar² are selected from the group consisting of cyclopentadienyl, dicarbollide and phenyl, each of which can be optionally substituted.

20. The method of claim 17, wherein each of X¹, X² and X³ is independently a bond or O.

21. The method of claim 17, wherein R² and R³ are C₁-C₆ alkyl.

22. The method of claim 17, wherein said solid support is glass or a polymeric resin.

23. The method of claim 22, wherein said polymeric resin is selected from the group consisting of acrylic ester, polyvinyl, polystyrene, polypyrrole, polyolefin, and polyaromatic.

24. The method of claim 17, wherein Y is selected from the group consisting of nitrate, halide, HSO₄⁻, ClO₄⁻, ReO₄⁻, PF₆⁻, carboxylate and CF₃SO₃⁻.

25. The method of claim 17, wherein a is 1 when said ion coordinating agent is activated.

26. The method of claim 1, wherein said solution is an aqueous solution.

27. The method of claim 26, wherein the temperature of solution of said step (a) is least about 24° C.

28. The method of claim 1, wherein the temperature of said recovery solution is at least about 85° C.

29. The method of claim 28, wherein said recovery step (d) comprises reducing the temperature of said recovery solution to less than about 5° C. to precipitate said ion.

30. The method of claim 29, wherein said recovery step further comprises separating said precipitated ion from said recovery solution.

31. The method of claim 1, further comprising:
(e) re-activating said deactivated ion coordinating agent; and
(f) repeating said steps (a)-(e).

32. A method for removing and recovering an anion from an aqueous solution comprising:
(a) contacting said solution with a solid ion extractant comprising an ion coordinating agent to remove at least a portion of said anion from said aqueous solution, wherein said solid ion extractant is a composition of the formula: 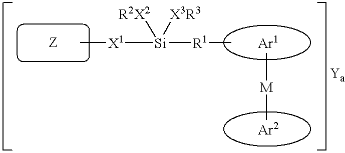
wherein
each of Ar¹ and Ar² is independently C₄-C₂₀ aryl;
M is a transition metal;
R¹ is C₂-C₂₀ alkylene;
each of X¹, X² and X³ is independently a bond, O, S, or NR⁴;
each of R², R³ and R⁴ is independently H, or C₁-C₆ alkyl;
Z is a solid support;
Y is an anion; and
a is an integer from 1 to 3;
(b) reducing said ion coordinating agent in said solid ion extractant such that a is 0;
(c) dissolving said anion in a recovery solvent and removing said anion from said solid ion extractant; and
(d) recovering said anion.

33. The method of claim 32, wherein said anion is a perfluoroalkyl sulfonate or perfluoroalkyl carboxylate.

34. The method of claim 32, wherein said step of removing said anion from said aqueous solution comprises an ion-exchange process.

35. The method of claim 32, wherein a in said step (a) is 1.

36. The method of claim 32, wherein said ion coordinating agent is redox-recyclable.

37. The method of claim 36, further comprising a step of oxidizing said ion coordinating agent from a=0 to a=1 prior to said step (a).

38. The method of claim 37, wherein said oxidizing step comprises an electrochemical oxidation process.

39. The method of claim 37, wherein said oxidizing step comprises a chemical oxidation process.

40. The method of claim 36, wherein said deactivation step comprises reducing said ion coordinating agent.

41. The method of claim 40, wherein said reducing step comprises an electrochemical reduction process.

42. The method of claim 40, wherein said reducing step comprises a chemical reduction process.

43. The method of claim 42, wherein said chemical reduction process comprises contacting said solid ion extractant with a deactivating solution.

44. The method of claim 43, wherein said deactivating solution comprises a compound selected from the group consisting of Na₄Fe(CN)₆, K₄Fe(CN)₆, Na₂S₂O₄, Cr²⁺ salt, V²⁺ salt and NaBH₄.

45. The method of claim 32, wherein M is selected from the group consisting of Fe, Ru, Mn, Co, Ni, Cr, Os, Rh and Ir.

46. The method of claim 45, wherein Ar¹ and Ar² are selected from the group consisting of cyclopentadienyl, dicarbollide and phenyl, each of which can be optionally substituted.

47. The method of claim 46, wherein each of X¹, X² and X³ is independently a bond or O.

48. The method of claim 47, wherein R²and R³ are C₁-C₆ alkyl.

49. The method of claim 48, wherein said solid support is glass or a polymeric resin.

50. The method of claim 49, wherein said polymeric resin is selected from the group consisting of acrylic ester, polyvinyl, polystyrene, polypyrrole, polyolefin, and polyaromatic.

51. The method of claim 50, wherein Y is selected from the group consisting of nitrate, halide, HSO₄⁻, ClO₄⁻, ReO₄⁻, PF₆⁻, carboxylate and CF₃SO₃⁻.

52. The method of claim 32, wherein the temperature of said aqueous solution of said step (a) is least about 24° C.

53. The method of claim 52, wherein the temperature of said recovery solution is at least about 85° C.

54. The method of claim 53, wherein said recovery step (d) comprises reducing the temperature of said recovery solution to less than about 5° C. to precipitate said anion.

55. The method of claim 54, wherein said recovery step further comprises separating said precipitated ion from said recovery solution.

56. The method of claim 32, further comprising:
(e) re-activating said deactivated ion coordinating agent; and
(f) repeating said steps (a)-(e).

57. A process for producing a solid ion extractant composition of the formula: 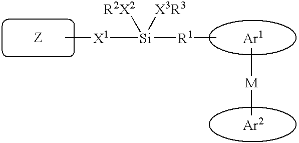
said process comprising contacting the solid support of the composition: 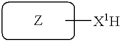
with an ion coordinating agent of the formula: 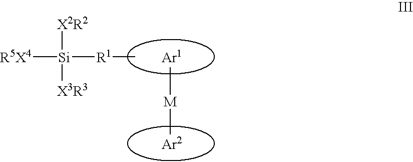
wherein
each of Ar¹ and Ar² is independently C₄-C₂₀. aryl;
each of X¹, X², X³ and X⁴ is independently a bond, O, S, or NR⁴;
R¹ is C₂-C₂₀ alkylene;
each of R², R³, R⁴ and R⁵ is independently H, or C₁-C₆ alkyl;
M is a transition metal; and
Z is a solid support.

58. The process of claim 57, further comprising the step of producing said ion coordinating agent, wherein said ion coordinating agent producing step comprises contacting an olefin of the formula: 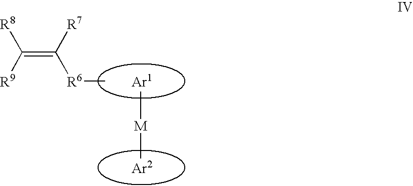
with a silyl compound of the formula HSi(X²R²)(X³R³)(X⁴R⁵) in the presence of a catalyst to produce said ion coordinating agent,
wherein
R⁶ is a bond or C₁-C₁₈ alkylene; and
each of R⁷, R⁸ and R⁹ is independently H or C₁-C₆ alkyl.

59. The method of claim 58, wherein said catalyst is selected from the group consisting of Karstedt's catalyst, Speier's catalyst, other silylplatinum complexes, transition metal nanoclusters, dicobalt octacarbonyl, nickel tetracarbonyl, Wilkonson's catalyst, chromium hexacarbonyl, and zirconocenes.

60. The process of claim 57, wherein M is selected from the group consisting of Fe, Ru, Mn, Co, Ni, Cr, Os, Rh and Ir.

61. The process of claim 60, wherein Ar¹ and Ar² are selected from the group consisting of cyclopentadienyl, dicarbollide and phenyl, each of which can be optionally substituted.

62. The process of claim 61, wherein each of X¹, X² and X³ are independently a bond or O.

63. The process of claim 62, wherein X⁴ is O.

64. The process of claim 63, wherein R², R³ and R⁵ are C₁-C₆ alkyl.

65. The process of claim 64, wherein said solid support is glass or a polymeric resin.

66. The process of claim 65, wherein said polymeric resin is selected from the group consisting of acrylic ester, polyvinyl, polystyrene, polypyrrole, polyolefin, and polyaromatic.

67. The process of claim 57, further comprising oxidizing said solid ion extractant to produce an activated solid ion extractant of the formula: 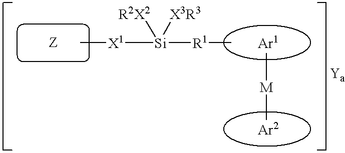
wherein
Y is an anion; and
a is an integer from 1 to 3.

68. The process of claim 67, wherein a is 1.

69. The process of claim 67, wherein Y is selected from the group consisting of nitrate, halide, HSO₄⁻, ClO₄⁻, ReO₄⁻, PF₆⁻, carboxylate and CF₃SO₃⁻.

70. The process of claim 67, wherein said oxidizing step comprises an electrochemical oxidation process.

71. The process of claim 67, wherein said oxidizing step comprises a chemical oxidation process.

72. The process of claim 71, wherein said chemical oxidation process comprises contacting said solid ion extractant with a solution comprising an oxidant to produce said activated solid ion extractant.

73. The process of claim 72, wherein said oxidant is selected from the group consisting of Fe(NO₃)₃, AgNO₃, FeCl₃, AgF, NaOCl, Ce(NH₄)₂(NO₃)₆ and Ce(SO₄)₂.

74. A compound of the formula: 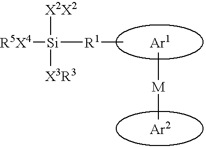
wherein
each of Ar¹ and Ar² is independently C₄-C₂₀ aryl;
each of X¹, X², X³ and X⁴ is independently a bond, O, S, or NR⁴;
R¹ is C₂-C₂₀ alkylene;
each of R², R³, R⁴ and R⁵ is independently H, or C₁-C₆ alkyl; and
M is a transition metal.

75. The compound of claim 74, wherein M is selected from the group consisting of Fe, Ru, Mn, Co, Ni, Cr, Os, Rh and Ir.

76. The compound of claim 74, wherein Ar¹ and Ar² are selected from the group consisting of cyclopentadienyl, dicarbollide and phenyl, each of which can be optionally substituted.

77. The compound of claim 74, wherein each of X¹, X², X³ and X⁴ is independently a bond or O.

78. The compound of claim 74, wherein R² and R³ are C₁-C₆ alkyl.
